(19) United States
(12) Patent Application Publication
(10) Pub. No.: US 2024/0082858 A1
(43) Pub. Date: Mar. 14, 2024

(54) METHOD AND APPARATUS FOR A POLYMER ELECTROSPRAY EMITTER

(71) Applicant: Massachusetts Institute of Technology, Cambridge, MA (US)

(72) Inventors: Paulo C. Lozano, Arlington, MA (US); Brian L. Wardle, Lexington, MA (US); Michael D. Canonica, Cambridge, MA (US); David Krejci, Wartberg (AT); Yue Zhou, Brookings, SD (US); Andrew Adams, Chapel Hill, NC (US)

(73) Assignee: Massachusetts Institute of Technology, Cambridge, MA (US)

(21) Appl. No.: 18/272,948

(22) PCT Filed: Nov. 19, 2021
(86) PCT No.: PCT/US2021/060055

§ 371 Date: Jul. 18, 2023

Related U.S. Application Data
(60) Provisional application No. 63/140,026, filed on Jan. 21, 2021.

(51) Int. Cl. B05B 5/053; B05B 5/025; H01J 49/16

(52) U.S. Cl. CPC B05B 5/0533; B05B 5/0255; H01J 49/165

(57) ABSTRACT

Polymeric electro spray emitters and related methods are generally described. In some embodiments, an emitter may be made from an ionic electro active polymer. The composition of the electro spray emitters described herein may enable the transport of ions and/or liquid ion sources, such as an ionic liquid or room temperature molten salt, through the bulk of the polymeric emitter. In some embodiments, the described emitters may be fabricated using a mixture of an ionic electroactive polymer, a solvent, and a liquid ion source to at least partially mitigate swelling effects of the polymer emitter that may otherwise occur when the one or more emitters are exposed to the liquid ion source during operation.

### CROSS-REFERENCE TO RELATED APPLICATIONS

This application claims the benefit of priority under 35 U.S.C. § 119(e) of U.S. provisional application Ser. No. 63/140,026, filed Jan. 21, 2021, the disclosure of which is incorporated by reference herein in its entirety.

### GOVERNMENT SUPPORT

This invention was made with Government support under Grant No. NRO000-13-C-0516 awarded by the National Reconnaissance Office, and under Grant No. FA9550-19-1-0104 awarded by the Air Force Office of Scientific Research. The Government has certain rights in the invention.

### FIELD

The disclosed embodiments are generally related to devices and methods for generating ions. More specifically, methods and apparatuses including embodiments related to polymer electrospray emitters are disclosed.

### BACKGROUND

Electric propulsion technologies such as ion engines and Hall effect thrusters make use of accelerating beams of ions with a combination of electric and magnetic fields to generate thrust. Electric propulsion systems typically feature higher specific impulse, or the amount of thrust produced per unit flow rate of propellant used, and greater mass savings in comparison with liquid and solid propellant chemical thrusters. The electrospray emitters used for these applications may be used in other applications as well where it is desirable to emit ions for a variety of reasons. Depending on the specific construction, the electrospray emitters may be connected with an ionic liquid source in a variety of ways. This may include pressure fed capillary emitters; capillary tube fed emitters; externally wetted emitters; and internally wetted porous emitters that use capillary pressure to feed the emitters.

### SUMMARY

In one aspect, the electrospray device may include a substrate and one or more emitters. The one or more emitters may extend from the substrate, and the one or more emitters may include an ionic electroactive polymer.

In another aspect, a method of operating the electrospray device may include applying a voltage differential to one or more emitters, and diffusing a liquid ion source through a material of the one or more emitters, and emitting ions from a tip of each of the one or more emitters.

In yet another aspect, a method of forming an electrospray emitter may include mixing a solution of a solvent, an ionic electroactive polymer, and at least one of an ionic liquid and a room temperature molten salt. The method also includes molding the mixture to form one or more emitters.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a schematic view of a prior art emitter;

FIG. 1B is a schematic view of the prior art emitter from FIG. 1A installed in an electrospray device;

FIG. 2A is a schematic view of one embodiment of an emitter;

FIG. 2B is a schematic view of the emitter from FIG. 2A installed in an electrospray device;

FIG. 3A is a scanning electron micrograph of an exemplary embodiment of a prior art emitter;

FIG. 3B is a scanning electron micrograph of an exemplary embodiment of an emitter;

FIG. 4 is a schematic view of one embodiment of an electrospray device;

FIGS. 5A-5E are a series of schematic views of one embodiment of a fabrication process of a structure including one or more emitters, according to an illustrative embodiment;

FIG. 6 is a schematic view of one embodiment of an electrospray device;

FIG. 7 is a flowchart illustrating two methods for manufacturing electrospray devices;

FIGS. 8A-8C are a series of schematic views of another embodiment of an electrospray device fabrication process according to an illustrative embodiment;

FIG. 9A is an isometric view of one embodiment of an electrospray device;

FIG. 9B is a schematic view of one embodiment of an emitter array included in an electrospray device;

FIG. 10A is a graph of the emitter current and source voltage over time;

FIGS. 10B-10C are micrographs of an exemplary embodiment of an emitter;

FIG. 11A is a graph of time-of-flight decomposition of an exemplary embodiment of an emitter; and

FIG. 11B is a graph of mass spectra from the time-of-flight decomposition of FIG. 11A.

### DETAILED DESCRIPTION

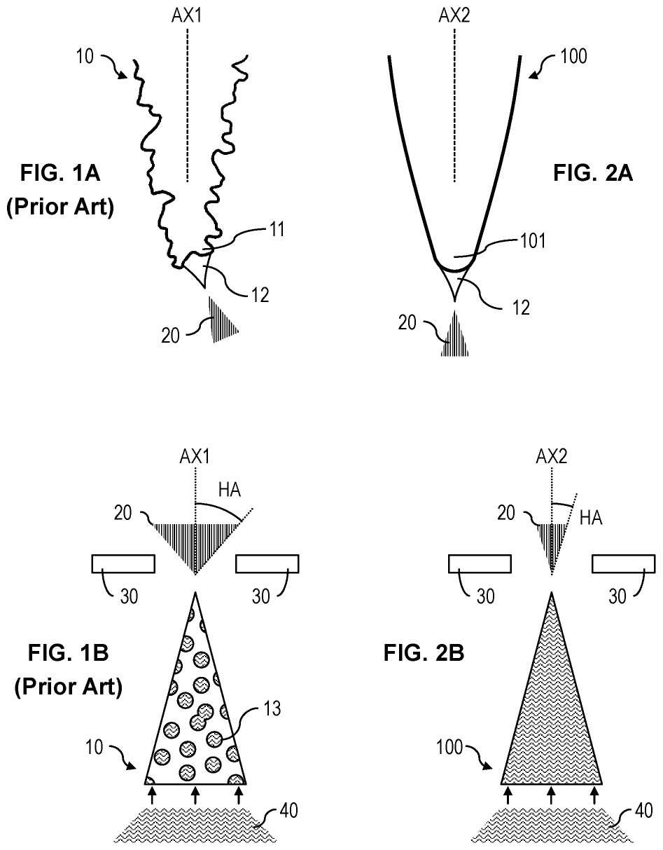

Existing electrospray emitters make use of capillary tubes, as described previously, surface textures, and/or porous materials to transport liquid ion sources (e.g. ionic liquids) to ion emission sites. Due to their confined nature, capillary tubes have some limitations such as unstable emission process, and issues with full blockage due to electrochemical reaction products or other contaminants. Electrospray emitters made with porous materials may also exhibit drawbacks due to the granular nature of these materials which may prevent controllable and smooth shaping of the emitter tips at their apex as described further below and illustrated in FIG. 1A where the external surface of the emitter is irregularly shaped. Similar issues may be present for externally wetted emitters which include structures formed on their exterior surface to transport an ion source, such as an ionic liquid, from a base of the emitter to a tip of the emitter. The Inventors have recognized that the lack of material and/or geometry uniformity of the emitter bodies of an electrospray device at the size scales relevant for ion emission may introduces variability in geometry and flow conditions in dense electrospray emitter arrays, which may in turn develop into operational differences between emitters. This may lead to degraded device performance and/or reduce operational lifetimes. For porous emitters where the liquid ion source (e.g. ionic liquid) flows within the pores and wets the outside of the emitters, the Inventors have also recognized there can be a lack of a clearly defined maximum potential gradient location which may cause off-axis emissions and increased half-angles HA of up to 60 degrees, as seen in FIG. 1B. As a result, ionic liquid can contaminate the nearby components, leading to life-limiting phenomena, such as material degradation and electrical shorts. Thus, the Inventors have recognized a need for an approach that enables precise shaping of the tip of the electrospray emitters included in a device. This type of control may enable better stability and efficiency of the electrospray device, while also enabling clusters of dense emitter arrays for high power density applications.

In view of the above, the Inventors have recognized the benefits associated with an electrospray emitter that is made using a substantially non-porous material that ions and/or a liquid ion source, such as a propellant, may be transported through. For example, the ions and/or the liquid ion source may diffuse through a solid portion of the emitter, which in some instances may extend from a base, or other appropriate portion, of the emitter to a tip of the emitter. In some embodiments, the liquid ion source and/or ions may diffuse through the solid non-porous portion of the one or more emitters when an electrical potential is applied to the one or more emitters during operation. In some embodiments, the emitters are made from a solid non-porous ionic electroactive polymer (IEP) that is configured to transport the associated ions and/or liquid ion source such that the ions may be emitted from a tip of the one or more emitters during operation. In some embodiments, the IEP may be electrically insulating.

In some embodiments, an emitter made from an IEP may exhibit better efficiency and an improvement of thrust (e.g. approximately 10 times greater) when compared to conventional ceramic or metallic micro/nano-porous emitters. For instance, in comparison with advanced plasma engines, which operate at the temperature limit of their refractory materials, in some embodiments, an IEP emitter may enable operation at temperatures approximately equal to an ambient temperature including, for example, room temperature. In some embodiments, the fabrication processes used to manufacture emitters including IEP may also enable better control over emitter tip morphology. In some embodiments, emissions from electrospray emitters made using the disclosed methods and materials may also be substantially ionic and stable for multiple hours of operation.

In addition to the above, the Inventors have recognized that a continuous material that is capable of diffusing an ion source, such as a propellant (e.g. ionic liquid), through the material either passively and/or under an applied electrical bias may improve meniscus location performance of the emitter tips associated with the one or more emitters. In these embodiments, the emitter conducts the liquid ion source and/or the ions through its bulk via the polymer free volume. Without wishing to be bound by theory, the IEP may permit the ions to diffuse through the free volume of the polymer to active (i.e. charged) sites within the polymer chain. In some embodiments, the IEP may be able to transport the ions and/or the ionic liquid through its bulk without any substantial amount of interconnected physical porosity in the emitter. The transport of molecular ions through the bulk of solid IEPs may help to provide a symmetric enhancement of electric fields via a surface that is consistent with the size and flow conditions of a stable ion-emitting menisci.

In some embodiments, the one or more disclosed emitters may be provided either be provided individually and/or in the form of an array. These one or more emitters may be made according to any of the embodiments described herein and may be integrated into an electrospray device configured for electrospray propulsion. However, it should be understood that the electrospray emitters and devices described herein may be used for other applications as well. The working principle of electrospray propulsion is based on the electrostatic extraction and acceleration of positive and/or negative ions from a (room-temperature) ionic liquid source. In some embodiments, the emitter is positioned downstream from a propellant source (e.g. ionic liquid) and upstream from an extractor. In some embodiments, the extractor may be a metallic aperture. For instance, the aperture may be formed in a grounded stainless-steel plate. When a voltage differential is applied between the propellant source and the extractor, an ion beam may be produced.

The ionic electroactive polymers (IEP) used with the various embodiments disclosed herein may correspond to any appropriate IEP capable of being used with the desired ion source, such as a desired propellant, and the specific device construction and desired operating parameters. In some embodiments, the IEP may be a sulfonated tetrafluoroethylene based fluoropolymer-copolymer (e.g. Nafion). Without wishing to be bound by theory, a sulfonated tetrafluoroethylene based fluoropolymer-copolymer is capable of absorbing water and ionic liquid on the nanometer scale due to the interactions between its perfluorinated backbone and sulfonic acid groups on its side chains. As a result, a sulfonated tetrafluoroethylene based fluoropolymer-copolymer may rearrange its internal structure to accept an ionic liquid and may change its surface properties when in contact with an ionic liquid. Upon absorption of sufficient water or ionic liquid, the sulfonated tetrafluoroethylene based fluoropolymer-copolymer may allow charges to be transported throughout its bulk while maintaining structural integrity. However, while a specific polymer is noted above, it should be appreciated that the IEP included in an emitter may also include polytetrafluoroethylene (PTFE), poly(vinylidene fluoridechlorotrifluoroethylene) (P(VDF-CTFE)), poly(vinylidene fluoride-trifluoroethylene-chlorofluoroethylene) (P(VDF-TrFE-CFE)), poly(3,4-ethylenedioxythiophene) (PEDOT), polyaniline, polypyrrole, or any combination of the above noted polymers as the present disclosure is not so limited.

In some embodiments, the emitter geometry (e.g., size and/or shape) may affect the emitter current. In some embodiments, a transverse cross-sectional area of the emitter normal to the flow path of the ionic liquid may be greater at a distal portion of the extractor than at a proximal portion of the extractor. For example, the emitter may be a substantially conical shape. In some embodiments, the cross-sectional area of the emitter may decrease linearly in a distally oriented direction oriented towards the extractor. In other embodiments, the cross-sectional area of the emitter may decrease nonlinearly from a proximal portion to a distal portion of the extractor. In some embodiments, the cross-sectional area of the emitter may decrease with a combination of linear and non-linear geometries as the disclosure is not limited in this fashion. In some embodiments, a profile of an emitter may be curved between a proximal and distal portion of the emitter. In some embodiments, the cross-sectional area of the emitter normal to the flow path of the ionic liquid may monotonically decrease between a proximal portion and distal portion of the emitter. In other embodiments, the cross-sectional area of the emitter may span any suitable combination of monotonic and/or non-monotonic variations. Of course, while decreasing cross sectional areas are discussed above, it is also contemplated that an emitter may include one or more portions of the emitter body that have substantial constant cross sections (e.g. cylindrical portions). Accordingly, it should be understood that the currently disclosed emitters are not limited to any particular emitter body geometry. For example, any suitable morphology or geometry of the emitter may be used, including, but not limited to, conic, spherically blunted conic, bi-conic, tangent orgive, elliptical, parabolic, hyperbolic, parabolic horn, needle like structures, or any combination thereof, as the present disclosure is not so limited. Further, in some embodiments, the emitter tip of an emitter may be located on a central axis of the emitter aligned with the flow of propellant through the emitter body such that the tip is the closest portion of the associated emitter to an extractor of a device. It should be appreciated that the emitter tip may include any suitable geometry to enable substantially axial emission of ions as the present disclosure is not so limited.

To facilitate the transport of an ion source through the bulk of an emitter, it may be desirable to reduce the diffusion distance that the ions and/or ion source may diffuse through prior to being emitted from a tip of an emitter. Accordingly, in some embodiments, the one or more emitters included in a device may be at least partially hollow where an internal cavity extends from a proximal end of an emitter to a distal portion of the emitter that is located proximally from the associated emitter tip. This internal cavity may be in fluid communication with a reservoir including a liquid ion source, e.g. a propellant, such that the liquid ion source may be transported to the cavity. The liquid contained within the internal cavity is isolated from the surrounding environment by the intervening exterior walls of the emitter body which may be made from a solid substantially non-porous material as noted above. Alternatively, an IEP might be applied to the surface of an already existing emitter, or array of emitters, such that the IEP forms an external surface or skin around the emitter(s). The IEP might be deposited onto already formed emitter bodies and/or substrates using a variety of methods including, but not limited to molding, chemical or physical vapor deposition, spin coating, dip coating, and/or any other appropriate method. In either case, the liquid and/or ions may diffuse from the internal cavity or inner porous portion of the emitter body to the emitter tip through the intervening walls of the IEP located on an external portion of the emitter.

As described previously, an ionic beam emitted from an electrospray device may originate at the emitter tip of an associated emitter, such that the electrospray device may emit ions from the tip of the emitter. To facilitate the emission of well controlled ion beams, the emitter bulk may be substantially homogenous and an exterior surface of the emitter may be relatively smooth. In some embodiments, a surface roughness, such as a root mean square roughness, of an exterior surface of the emitter body may be less than or equal to 10 μm, 1 μm, 500 nm, 100 nm, 10 nm, and/or any other appropriate size scale. This surface roughness may be measured using any appropriate characterization technique including laser scanning confocal microscopy and atomic force microscopy. Providing emitters with a relatively low surface roughness may promote the formation of a stable electrified liquid meniscus at the associated tip. This may also reduce deviation of the ion beam from the axial direction of the emitter.

As noted above, in some embodiments, an electrospray device may also include an extractor electrode positioned downstream relative to the one or more emitters of a device. In some embodiments, the extractor electrode may be connected to a power source, which may apply a voltage differential to a reservoir including an ion source, such as a propellant, and the extractor electrode. It should be appreciated that the extractor electrode may be made from any appropriate material (e.g. conducting or semiconducting) capable of applying a voltage potential relative to the reservoir, including, but not limited to silver, stainless steel, tungsten, nickel, magnesium, molybdenum, titanium, any combination thereof, or any of these metals coated with a noble metal material such as platinum or gold, as the present disclosure is not so limited.

In some embodiments, the electrospray device may include a substrate from which one or more emitters extend distally from. In some embodiments, the substrate may provide structural rigidity to help maintain the one or more emitters in a desired position and/or orientation during operation. Depending on the application, the emitters may either be disposed on and attached to the substrate and/or the emitters may be integrally formed with the substrate as the disclosure is not limited in this fashion. In some embodiments, the substrate may be generally planar. In other embodiments, the substrate may include structural nonlinearities. Thus, it should be appreciated that the substrate may be any suitable geometry. Further, in some embodiments, the liquid ion source may be coupled to the one or more emitters through the substrate. This may include the use of substrates including through holes, porous materials, and/or materials, such as the disclosed ionic electroactive polymers, that the ions and/or liquid ion source may diffuse through.

As described above, in some embodiments, an electrospray device may include a substrate coupled to a reservoir. The reservoir may hold a desired volume of an ion source, such as a propellant, for use during the duration of operation of the electrospray device. In some embodiments, the reservoir may include structures capable of passively feeding propellant to the substrate, the emitter, or other structures of the system. In some embodiments, the structure of the reservoir is such that the propellant may be continuously transported through capillarity to the emitter tip as to provide propellant without an active pump. Non-limiting examples of structures capable of passively feeding propellant may include, but are not limited to, a pore size gradient, grooves, cylindrical tubes, thin plate-shaped openings, or a combination thereof, and/or any other appropriate structure. For example, in one embodiment, the one or more components of the electrospray device may be assembled such that a network of pores extends from the reservoir to the substrate. Further, to help facilitate the flow of propellant toward the emitter, in an electrospray device including one or more porous components, a pore size gradient across the one or more components may be selected such that the pore size of the different components decreases in a downstream direction directed towards the emitter, or other appropriate outlet of the electrospray device. In such an embodiment, the average pore size of upstream components may be larger than the average pore size of the associated downstream components. Of course, while embodiments including pores have been described, embodiments in which other structures such as grooves, tubes, surface protrusions/features, materials capable of diffusing the ions and/or liquid ion source, and/or any other construction capable of transporting propellant to a desired portion of the electrospray device may also be used as the disclosure is not so limited.

The different components located along a flow path of an ion source and/or the associated ions, through a device may include, for example, a reservoir, substrate, scaffolding, and/or housing (as described in more detail below). These components may be made from any appropriate material that is compatible with the associated ion source, ions, and anticipated operating conditions. In some embodiments, the components may facilitate the flow of fuel from a reservoir to the emitter. Thus, the components may be located along a flow path between the ion source (e.g., ionic liquid) and the ambient environment outside of the electrospray device. In some embodiments, the components may include material to enable passive internal fuel transport from the reservoir to the emitter. In some embodiments, the components may include the same material as the emitter. Thus, in some embodiments, the components may be made from one or more IEPs as described previously. In some embodiments, the components may include solid dielectric materials (e.g., a ceramic, glass, or other oxide material), carbon, metallic materials (e.g., silver, stainless steel, tungsten, nickel, magnesium, molybdenum, titanium, any combination thereof, or any of these materials coated with a noble metal material such as platinum or gold), and/or any other desirable material, as the present disclosure is not so limited.

It should be understood that depending on the particular type of electrospray device and the desired application, any appropriate type of ion source, such as a propellant, may be used with any of the electrospray device embodiments disclosed herein. This may include, for example, a source of ions this is liquid at the desired operating temperatures which may include an ionic liquid, a room-temperature molten salt, and/or any other appropriate ion source. Examples of ionic liquids that may be used as liquid ion sources may include but are not limited to EMI-BF₄ (1-ethyl-3-methylimidazolium tetrafluoroborate), EMI-CF₃BF₃ (1-ethyl-3-methylimidazolium trifluoromethyltrifluoroborate), EMI-GaCl₄ (1-ethyl-3-methylimidazolium tetrachlorogallate), EMI-Im (1-ethyl-3-methylimidazolium bis(trifluoromethylsulfonyl)imide), mixtures containing EMIF·2.3 HF (1-ethyl-3-imidazolium fluoride), BMI-BF₄ (1-butyl-3-methylimidazolium tetrafluoroborate), BMI-CF₃BF₃ (1-butyl-3-methylimidazolium trifluoromethyltrifluoroborate), BMI-GaCl₄ (1-butyl-3-methylimidazolium tetrachlorogallate), BMI-Im (1-butyl-3-methylimidazolium bis(trifluoromethylsulfonyl)imide), or mixtures containing BMIF·2.3 HF (1-butyl-3-imidazolium fluoride). It should be appreciated that any suitable ionic liquid, or other ion source, capable of providing sufficiently high conductivity and high surface tension for a desired application may be used as the present disclosure is not so limited.

In some embodiments, an electrospray device may include a plurality of emitters disposed in a one-dimensional or two-dimensional array. The fabrication process used to realize the plurality of emitters may allow for a dense array of emitters with substantially consistent geometries, such that each emitter may have similar emission characteristics. An array of emitters may be useful for high power density applications. In some embodiments, an electrospray device with an emitter array may include a common reservoir that is coupled with each emitter such that the liquid ion source and/or the ions may be transported from the reservoir to each of the emitters. In some embodiments, the electrospray device may also include an extractor grid with corresponding apertures aligned with each of the one or more emitters included in the emitter array. In some embodiments, the electrospray device may include scaffolding to ensure rigid coupling between the emitter array, the reservoir, and/or the extractor grid. As described in further detail below, the number of emitters included in an emitter array may be determined by the pitch distance between neighboring emitters, the overall geometric footprint of the electro spray device, and/or predetermined power requirements. It should be appreciated that any array pattern or geometry (e.g. pitch distance, number of emitters) may be used, as the present disclosure is not so limited.

As described previously, in some embodiments, a liquid ion source and/or the associated ions may be transported to a tip of an emitter through the bulk of the emitter. In some embodiments, this bulk transport of ion source and/or ions may occur in the absence of substantial physical porosity. In other words, the emitter may include a solid IEP which may be characterized as being substantially non-porous. A non-porous material may have a porosity that is less than or equal to 5%, 4%, 3%, 2%, 1%, 0.5%, or any other appropriate percentage. Additionally, in some embodiments, the plurality of pores present in a substantially non-porous material may not be interconnected such that material passes through the bulk of the material and not through the pores of the material.

For the sake of clarity, the embodiments described below are primarily directed to electrospray emitters used in a propulsion system in which the liquid ion source is referred to as a propellant. However, it should be understood that the disclosed embodiments are not limited to only propulsion systems. Accordingly, the term propellant as used herein may be used interchangeably with the more general term ion source, liquid ion source, or other similar term in the various embodiments described herein as the disclosure is not limited in this fashion.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein. For example, while all the embodiments described herein refer to electrospray devices, the emitter may be configured for any ion generation device, for example rocket propulsion for deep space application, as the present disclosure is not so limited.

FIGS. 1A and 1B show representative prior art emitters which may include porous or granular material. As can be seen in a close-up view from FIG. 1A, the prior art emitter 10 includes a non-uniform tip 11 due to the material non-uniformities present in the emitter which may result in a meniscus 12 and subsequent ion beam 20 which may be oriented in a direction that deviates from the central axis AX1 of the emitter 10. FIG. 1B shows a similar prior art emitter 10 coupled to a source of a propellant 40 through pores 13 formed in the emitter. The depicted emitter is operated to emit an ion beam 20 from a distal tip of the emitter. As shown schematically in FIG. 1B, the ion beam emitted from the emitter may be relatively wide due to the non-uniformities present in the emitter shown in FIG. 1A. Specifically, due to the off-axis meniscus 12 shown on the non-uniform tip 11 of the prior art emitter 10 in FIG. 1A, the ion beam 20 may be characterized with a larger half-angle HA with respect to the central axis AX1 that is larger than might be expected given the nominal geometry and operating parameters of the emitter.

As shown in FIG. 2A, in some embodiments, the emitters 100 described herein may exhibit a substantially smooth tip 101, where the meniscus 12 formed during operation of the electrospray device may occur substantially along the central axis AX2 of the emitter 100. Accordingly, the resultant ion beam 20 may be substantially aligned with the central axis AX2 of the emitter 100. As further shown in FIG. 2B, the ion beam 20 emitted from the emitter 100 may exhibit smaller half angles HA when compared to the prior art emitter 10 shown in FIG. 1B. Additionally, as shown in FIG. 2B, the emitter 100 may conduct propellant 40 through its bulk rather than through pores, and may therefore exhibit more efficient operation, as described previously.

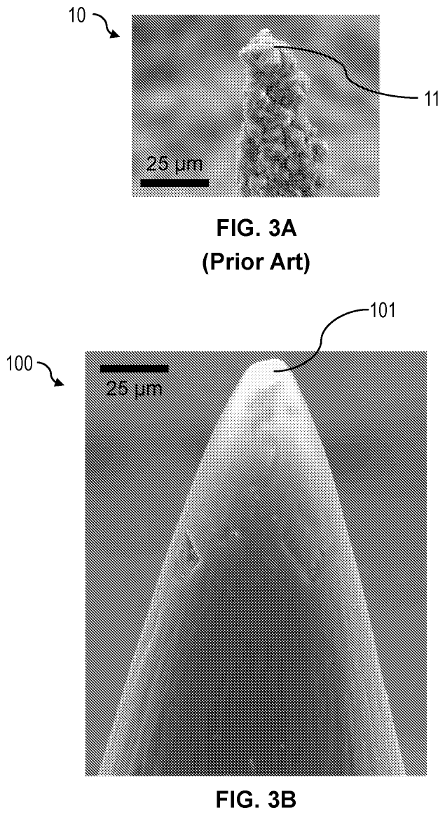

FIG. 3A is a scanning electron micrograph of an exemplary prior art emitter 10 composed of borosilicate glass, showing the granularity and non-uniformity of the emitter 10 at the tip 11. FIG. 3B is a scanning electron micrograph of an exemplary emitter 100 composed of a sulfonated tetrafluoroethylene based fluoropolymer-copolymer (e.g. Nafion), though other IEPs may also be used as described previously. The difference in the uniformity and relatively smooth surface of the emitter body enabled by the use of an IEP is clearly illustrated by the smooth uniform tip 101 depicted in the figure.

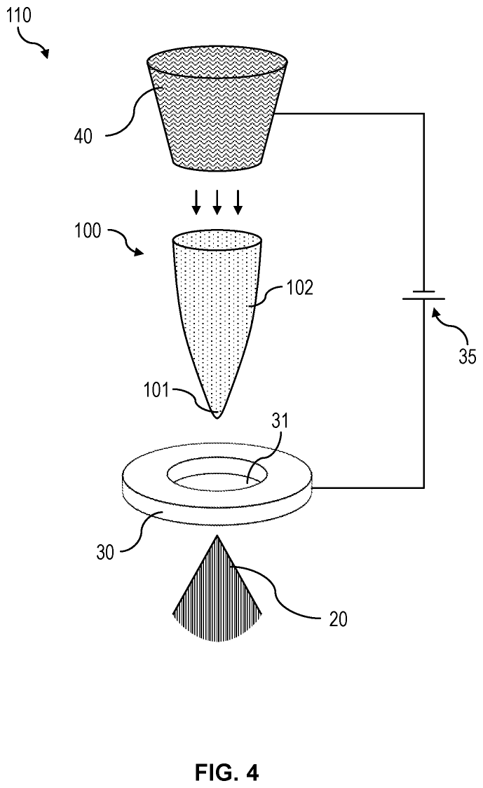

As shown in FIG. 4, in some embodiments, an electrospray device 110 may include a source of propellant 40, an emitter 100, and an extractor electrode 30. In the depicted embodiment, the propellant source 40 may be located upstream from the emitter 100 and the extractor 30. The emitter 100 may be located downstream from the propellant source 40 and upstream from the extractor 30 with the extractor 30 located downstream from both the propellant source 40 and the emitter 100. As described previously, a power source 35 may be electrically connected to the extractor 30 and the emitter. In the depicted embodiment, an upstream electrode connected to the power source, not depicted, may be electrically coupled to the emitter through the liquid ion source contained in the depicted reservoir such that a voltage differential may be applied across the electrospray device 110. In some embodiments, the emitter 100 may be coupled with the propellant source 40 such that the emitter 100 may transport propellant 40 and/or ions of the propellant from a proximal portion of the emitter 100 to the emitter tip 101, through the emitter bulk or body 102 due to the properties of the IEP discussed previously.

In some embodiments, upon application of a threshold voltage, the electrospray device 110 may emit an ion beam 20 from the emitter tip 101. Accordingly, the extractor electrode 30 may include one or more apertures 31 associated with each corresponding emitter to allow the one or more ion beams 20 to be emitted from the emitters and pass through the extractor. In other words, in some embodiments, the power source may apply a voltage differential to the propellant source 40 relative to the extractor 30, thereby emitting a current (e.g., an ion beam 20) from the emitter tip 101. The application of a voltage can cause formation of a meniscus (e.g., as shown in FIG. 2A) at the emitter tip 101 and cause the emission of ions from the emitter tip 101. Further components of the electrospray device 110 will be described in more detail below.

In some embodiments, the emitter, the plurality of emitters, or any of the components listed previously (e.g. substrate, reservoir, scaffolding) may be fabricated using any appropriate method. In some embodiments, the components may be manufactured using any suitable combination of additive and subtractive techniques. In some embodiments, additive techniques include, but are not limited to, multiphoton lithography, direct-write techniques, electrochemical deposition, dip-pen nanolithography, molecular self-assembly, femtosecond projection two-photon lithography, chemical vapor deposition, physical vapor deposition, polymer chemical vapor deposition, deposition of nano-beads, molding, casting, layer-by-layer deposition via alternating charged polymer solutions, and/or any other appropriate manufacturing technique as the present disclosure is not so limited. In some embodiments, subtractive techniques include, but are not limited to, chemical wet etching, plasma dry etching, ion beam milling, laser milling, micromachining, machining, lithography, nanolithography, or focused ion beam lithography, and/or any other appropriate manufacturing technique as the present disclosure is not so limited. Combinations of the forgoing may also be used. Accordingly, the current disclosure should not be limited to any particular form of manufacturing techniques for the various components disclosed herein.

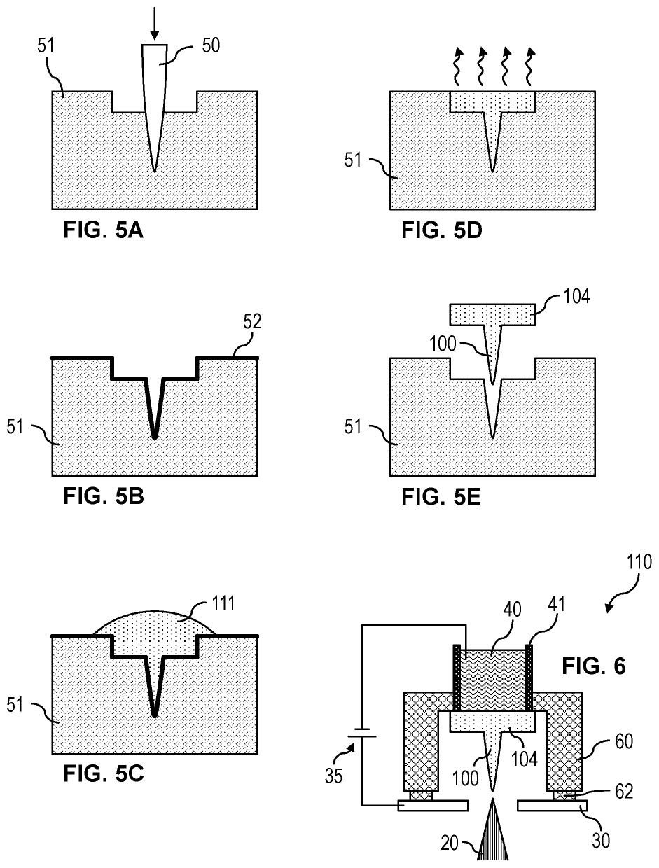

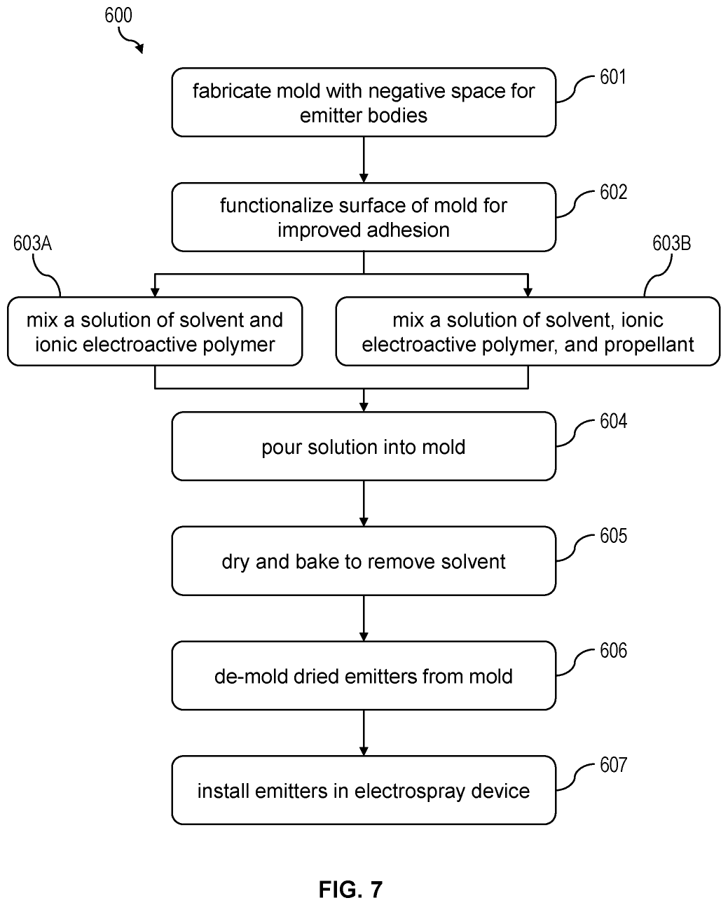

In some embodiments, an electrospray device 110 may be fabricated using a casting process. As shown in FIG. 5A and FIG. 7, a suitable mold 51 may first be formed with a master 50 to establish a negative imprint of the master 50 in the mold 51, according to step 601. In some embodiments, the master 50 may be a needle, such as a Tungsten needle, that is pressed into a material of the mold to form the desired cavity. In some embodiments, the master 50 may be a needle that has undergone electrochemical etch processing to smooth and sharpen the tip of the master 50. The processing may include an AC conditioning step, a DC etching step, an AC blunting step, and a micro-etching step, although any combination of processing steps may be used as the present disclosure is not so limited.

In some embodiments, the master 50 may include positive features corresponding to either a single or a plurality of emitters 100. These features may be fabricated using for example silicon microfabrication, multiphoton lithography, laser ablation, or any other suitable process, as the present disclosure is not so limited. In some embodiments, the master 50 may further include a positive impression of the substrate in addition to the one or more emitters such that the emitters may be formed integrally with the substrate. As described previously, the one or more emitters 100 may have any suitable geometry, as the present disclosure is not so limited, and accordingly, the master 50 may have geometries that are different from the conical needle shown in the figures as the present disclosure is not so limited.

While a particular mold manufacturing method is shown above, the mold may be made from any appropriate material and may be manufactured in any appropriate fashion. For instance, in some embodiments, a mold 51 for the emitter 100 may be made from polydimethylsiloxane (PDMS), polytetrafluoroethylene (PTFE), polymers, fluoropolymers, paraffin wax, silica, glass, aluminum, and/or stainless steel. In some embodiments, the mold can be polished to provide a smooth finish. For example, a solvent etching process may be conducted to achieve a smooth surface finish of the mold 51. Other appropriate manufacturing techniques may include: microfabrication techniques used to create molds 51 with suitably sized features (e.g., for forming emitters); silicon microfabrication to form the positive for the mold 51; laser ablation can be used to form small features (e.g., for forming emitters) in molds 51; stereolithography; fused deposition modeling; selective laser sintering; and/or, or any other suitable fabrication technique, as the present disclosure is not so limited.

In embodiments where the mold 51 includes PDMS, the polymer precursors may first be sufficiently mixed to initiate crosslinking of neighboring polymer chains. As shown in FIG. 5A, prior to substantial crosslinking of the PDMS mixture, the master 50 may be inserted or otherwise brought into contact with the mold 51. In some embodiments, the master 50 may be held in place to improve conformation of the mold 51 to the master 50. In some embodiments, the master 50 may be held in place for a sufficient duration of time, during which the mold 51 solidifies, crosslinks, or is otherwise cured to retain the negative shape of the master 50 upon removal of the master 50, as shown in FIG. 5B. In some embodiments, the mold 51 may be heated to expedite or otherwise aid the molding process. In some embodiments, the mold 51 may subsequently be functionalized using a functional layer 52 or otherwise activated with functional surface groups to improve wetting between the mold 51 and the mixture 111, as shown in step 602 of FIG. 7. In the exemplary embodiment where the mold 51 includes PDMS, the mold 51 may be exposed to oxygen plasma or ultraviolet light to hydroxylate the surface of the PDMS mold 51.

Next, according to FIG. 5C, a mixture 111 may be prepared (shown as step 603A in FIG. 7) and poured into the mold 51 (shown as step 604 in FIG. 7). In some embodiments, the mixture may include an IEP and a suitable solvent. In some embodiments, the dissolution of the IEP in the solvent may enable sufficient flow of the mixture 111 such that the mixture 111 may conform to the mold 51. As described below, the solvent may be removed from the electro spray device 110 prior to operation, such that the molded component of the electrospray device 110 (e.g. emitter 100 or substrate 104) may not include a significant amount of solvent. For example, the final extractor may include less than 1 wt %, 0.5 wt %, 0.1 wt %, or any other appropriate weight percentage solvent after solvent removal. In some embodiments, the solvent may be any anhydrous solvent capable of dissolving the IEP, including, but not limited to, N-methyl-2-pyrrolidinone, dimethylacetamide, dimethyl sulfoxide, methanol, methane sulfonic acid, tetramethylene sulfone, phenyl sulfone, 1-methyl-2-pyrrolidinone, N, N-dimethylformamide, or any other suitable solvent, as the present disclosure is not so limited. In an exemplary embodiment, the IEP is a sulfonated tetrafluoroethylene based fluoropolymer-copolymer and the solvent is N-methyl-2-pyrrolidinone where the mixture 111 includes 90% solvent by mass. In this exemplary embodiment, the mixture 111 may be heated to 80° C. and stirred to ensure sufficient dissolution of the IEP in the N-methyl-2-pyrrolidinone solvent for a time period to provide a fully dissolved mixture prior to pouring the mixture into the mold. After dissolution has occurred, an additional 15 minutes of heating and stirring may be applied to prevent flecks. Subsequently, the solution may be cooled to room temperature while the mixture 111 continues to be stirred. While specific percentages, times, and temperatures are noted above, different combinations of processing parameters may be used depending on the specific materials and components to be formed.

When added to the mold, in some embodiments, an excess amount of the mixture may be applied relative to a final desired net shape of the emitter as shown by the meniscus extending above the mold 51 shown in FIG. 5C. To reduce the formation of pores in the emitter body, the surface functionalization 52 of the mold 51 may help to prevent the mixture 111, which may be viscous in some embodiments, from trapping bubbles within small features of the mold 51. The mixture 111 may also undergo a degassing process to remove any gas that may be trapped between the mold 51 and the mixture 111 prior to the curing process.

In some embodiments, the solvent may be removed from the mixture 111 prior to removal from the mold 51 (shown as step 605 in FIG. 7). In some embodiments, the solvent removal (shown in FIG. 5D) may include baking and/or application of low pressure to expedite the evaporation of the solvent out of the mixture 111 which may result in a net shrinkage of the material pool present in the mold. Accordingly, as noted above, the mold may be configured to accommodate an excess volume of the mixture to provide a desired net shape after shrinkage of the mixture during solvent removal. In the exemplary embodiment of a sulfonated tetrafluoroethylene based fluoropolymer-copolymer and N-methyl-2-pyrrolidinone, the mold may first be desiccated for 30 minutes to an hour before heating at 80° C. for at least two hours to remove the solvent after a manual desiccation process. However, other manual and/or automated solvent removal processes may also be used. In some embodiments, steps 604 and 605 related to filling and solvent removal from FIG. 7 may be repeated multiple times to deposit several layers of material in the mold to accommodate large mixture shrinkages when the solvent ratio is sufficiently high such that the remaining IEP after evaporation or removal of solvent may not sufficiently fill the mold 51.

Upon substantial removal of the solvent from the mixture 111, the emitter 100 may be de-molded from the mold 51, as shown in FIG. 5E and step 606 of FIG. 7. As described previously, in some embodiments, the substrate 104 may facilitate de-molding of the emitter 100 from the mold 51. Accordingly, in some embodiments, the substrate 104 may be fabricated along with the emitter 100. In some embodiments, the substrate 104 may provide a relatively large surface area with which the operator may use to retract the emitter 100 from the mold 51. While the schematics of FIGS. 5A-5E involve the molding of an emitter 100 with a substrate 104, the casting process described herein may be used to fabricate any component of the electrospray device 110, as the present disclosure is not so limited.

Once an emitter 100 (or any other component of the electrospray device 110) has been manufactured, using for example, the process illustrated above, the emitter may be installed in an electrospray device as shown in FIG. 6 and step 607 of FIG. 7. In some embodiments, this step involves the installation of the emitter 100 and substrate 104 on a scaffolding 60 or other structure. In some embodiments, the scaffolding 60 may align the one or more emitters 100 with one or more corresponding apertures formed in an extractor 30 disposed downstream from the extractor in a distally oriented direction. The extractor 30 may be disposed on spacers 62 between the extractor 30 and the scaffolding 60. The spacers 62 may be made from a sufficiently electrically insulating material and may have appropriate dimensions to maintain the extractor 30 electrically isolated from the emitter 100 and the reservoir 41. In some embodiments, the spacers 62 may inhibit propellant 40 from migrating to the extractor 30 and causing a short. In some embodiments, the substrate 104 may be coupled to a propellant reservoir 41 which may be configured to hold a desired volume of a propellant. In these embodiments, upon the application of a threshold voltage differential between the emitter and the extractor by an electrically coupled power source 35, an ion beam 20 may be emitted from the emitter 100, indicating propellant flow from the reservoir 41 to the extractor 30 through the substrate 104 and the bulk of the emitter 100. Prior to use, it may be desirable to remove any unwanted residual materials from the assembled device. Accordingly, in some embodiments, the electrospray device 110 may be placed in a vacuum chamber or otherwise exposed to low pressure to remove residual water vapor, solvent, or any other volatile compound present in the electro spray device 110.

In some embodiments, the emitter 100 may be wetted with the propellant 40 prior to operation. In some embodiments, the emitter 100 may be wetted by injecting the propellant 40 into the reservoir 41. In some embodiments, the emitter 100 may be wetted with the propellant 40 and allowed to penetrate the IEP by baking at a predetermined temperature. In the exemplary embodiment of a sulfonated tetrafluoroethylene based fluoropolymer-copolymer emitter 100 and EMI-BF₄ as the propellant 40, a droplet of the propellant 40 may be added to the non-emission end of the emitter 100 (e.g. the substrate 104) and the emitter may be baked at 80° C. for 24 hours. It should be appreciated that the absorption of propellant 40 by the IEP emitter 100 may be improved and/or expedited with heating, though the application of different temperatures and/or durations as well as exposure of the emitter to the propellant at a different location on the emitter may also be used as the disclosure is not limited to the above example.

As described previously, in some embodiments, due to the material properties of the substrate 104 and/or the reservoir 41, the propellant 40 may be transported to the tip 101 (see FIG. 4) of the emitter 100 through the bulk 102 of the emitter body. In some embodiments, the reservoir 41, and the ion source, such as the depicted propellant 40, disposed in the reservoir may be coupled with the emitter 100 such that the propellant 40 may be transported from the reservoir 41 to the emitter tip 101. In some embodiments, the transport of propellant 40 from the reservoir 41 to the emitter tip 101 may include transport through the substrate 104. For example, in some embodiments, the substrate 104 may be located downstream from the reservoir 41, as shown in FIG. 6. As described previously, the reservoir 41 may be electrically coupled to a first electrode, not depicted, such that the emitters are coupled to the first electrode through the ion source. A corresponding power source may be connected to both the first electrode and the extractor 30 (i.e. the extractor electrode) to apply a desired voltage differential between the one or more emitters and the extractor. In some embodiments, the extractor 30 may be downstream relative to the reservoir 41. It should be appreciated that the electrospray device 110 may include any number of other components not included in FIG. 6 as the present disclosure is not so limited.

The inventors have recognized that in some embodiments, due to the capacity of the ionic electroactive material (e.g. IEP) to absorb the propellant 40, the emitter 100 may undergo swelling when exposed to the propellant 40 prior to and/or during operation of the electrospray device 110. In some instances, the swelling of the emitter 100 may change the emitter shape, geometry, position and/or alignment with respect to the extractor aperture 30 and/or other components of the device. Shifts in position and/or alignment of the emitter tip(s) 101 of a device with respect to the extractor aperture(s) 30 may contaminate or degrade the device 110, and/or may cause electrical shorts.

The Inventors have also recognized that, in embodiments where the substrate 104 is made from a porous material (as described above), the fabrication process of the emitter 100 and substrate 104 may allow the IEP to penetrate into the pores of the substrate 104 during desiccation or immersion in similar low pressure environments, which may subsequently prevent the IEP from swelling or conducting the propellant 40. Therefore, the flow of propellant 40 between the substrate 104 and/or the reservoir 41 and the emitter tip 101 may be choked, which may negatively affect the efficiency of the electrospray device 110.

In view of the above, it may be desirable to mitigate, or substantially eliminate, the noted effects of swelling of components made with an IEP when exposed to an ion source such as the disclosed propellants. Accordingly, in some embodiments, an emitter 100 may be formed with a mixture including an IEP, a suitable solvent, and a propellant (e.g. a liquid ion source such as an ionic liquid), as shown in step 603B in FIG. 7. In other words, in some embodiments, the emitter may be pre-infused with the propellant prior to the manufacturing and operation of the electrospray device. Since the emitter already includes a desired amount of the propellant in the material, additional swelling and shape changes of the emitter may be avoided. In these embodiments, the fabricated emitter may include both the IEP and the propellant once the solvent has substantially evaporated out of the emitter. While the specific amount of a propellant included in a final component may vary depending on the specific materials used, in some embodiments, an emitter may include an IEP and a propellant with a weight percentage of the propellant in the component that is greater than or equal to 5 wt %, 10 wt %, 20 wt %, 30 wt %, 40 wt %, and/or any other appropriate weight percentage. The weight percentage of the propellant in the emitter may also be less than or equal to 50 wt %, 40 wt %, 30 wt %, 20 wt %, 10 wt %, and/or any other appropriate weight percentage. Combinations of the foregoing ranges are contemplated including, for example, a weight percentage of the propellant in the emitter that is between or equal to 5 wt % and 50 wt % though other ranges both greater than and less than these are also contemplated. Again, these weight percentages may be present in the emitter after manufacturing and prior to the transport of the propellant through the emitter during operation. Depending on the amount of propellant included in the mixture during manufacturing, the weight percentage of the propellant may either stay substantially the same, or it may change, during operation of the device. Additionally, while such a construction may be advantageous to avoid swelling, embodiments in which the propellant is not included in the mixture during formation are also contemplated.

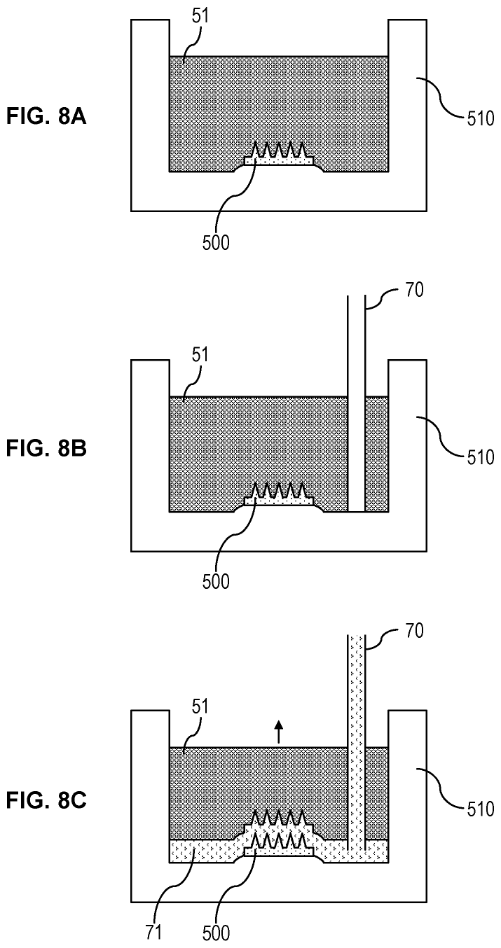

As described previously, in some embodiments, an electrospray device 120 may include an array of emitters 1000 which may be manufactured in a manner similar to that described above and/or in any other appropriate fashion. For example, in some embodiments the electrospray device 120 may be cast using a mold 51 formed with a master 500 including an array of emitter masters as shown in FIG. 8A. While the casting process described above and illustrated in FIGS. 5-7 may be used to fabricate the electrospray device 120 with an array of emitters 1000, given the complexity of the master 500, alternative casting processes may be used. As shown in FIG. 8A, in some embodiments, a pre-crosslinked mold 51 may be poured onto the master 500, which may be pre-formed (e.g. solid and/or crosslinked) and installed within a container 510 to retain its position during the casting process. The mold 51 may be degassed or otherwise processed to facilitate the viscous mold solution 51 conforming to the master 500.

To release the mold 51 from the master 500, in some embodiments, a channel 70 (e.g. syringe) may be introduced into the mold 51 after the solidification or crosslinking of the mold 51 (e.g. after baking or desiccation), as shown in FIG. 8B. The channel 70 may allow a releasing fluid 71 to be introduced at the interface of the master 500 and the mold 51, as shown in FIG. 8C. In this way, the mold 51 may be released from the master 500 and the container 510. In some embodiments, the fluid 71 flow may enable uniform release of the mold 51 from the master 500 while maintaining the integrity of the mold 51. It should be appreciated that while FIGS. 8A-8C depict the fabrication of a mold 51 with a master 500 with an array of emitters, the process depicted in FIGS. 8A-8C may be used to form a mold for any suitable component of the electrospray device (e.g. a single emitter, an array of emitters, a substrate, and combinations of the forgoing), as the present disclosure is not so limited.

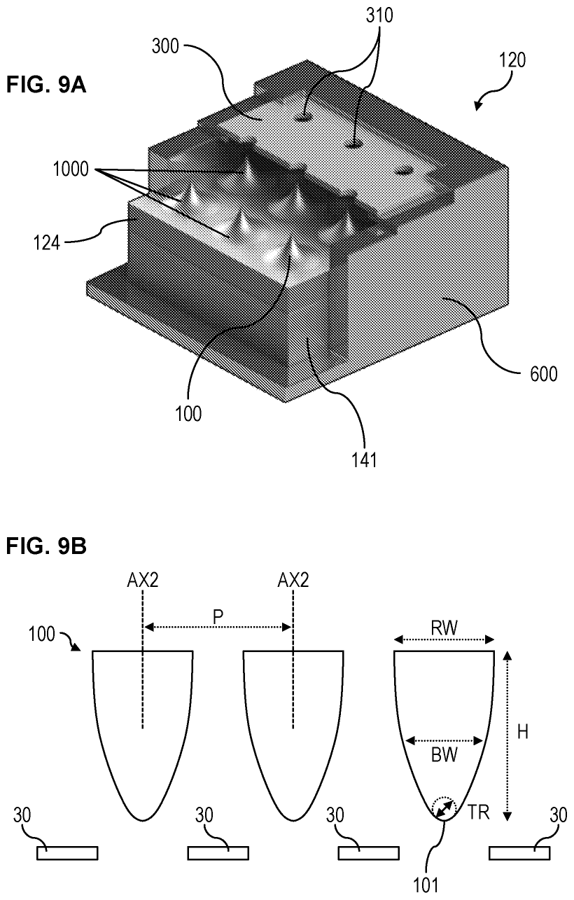

An embodiment of an electrospray device 120 including an array of emitters 1000 is shown in FIG. 9A. In the depicted embodiment, the array of emitters 1000 may share a common substrate 124 and/or a common reservoir 141. In these embodiments, each emitter 100 of the array of emitters 1000 may be fabricated with substantially similar geometries to ensure uniform emission from each emitter 100 during operation. In some embodiments, the electrospray device 120 may include an extractor grid 300 with an array of apertures 310. The array of apertures 310 may be aligned with the emitter array 1000 such that each emitter 100 tip is substantially centrally located within a single corresponding aperture. In some embodiments of the electrospray device 120, a housing or scaffolding 600 may be used to retain rigid positioning of the emitter array 1000 with the extractor grid 300 and any other component of the device. As described previously, pre-swelling of the emitter array 1000 with the propellant 40 may enable consistent registration between the array 1000 and the extraction grid 300 and/or maintain rigid contact between the emitter array 1000 and the substrate 124 or scaffolding 600.

In some embodiments of an electrospray device 120, the emitters of the emitter array 1000 may be separated by a pitch distance P, measured between the central axis AX2 of neighboring emitters 100, as shown in FIG. 9B. In some embodiments, the pitch distance P may be configured to substantially electrically and hydraulically isolate individual emitters 100 from one another. In some embodiments, such as the exemplary embodiment shown in FIG. 9A, when the emitter array 110 shares the same reservoir 141 or substrate 124, the pitch distance P may be chosen to maximize the number of emitters per area to reduce the overall size of the electrospray device. In some embodiments, the reduction of pitch distance may be in part related to the ability to controllably shape a smooth tip 101 on the emitter 100 due to the material properties of the IEP and the associated fabrication techniques. In an exemplary embodiment of the electrospray device 120 that was manufactured, the emitters of the emitter array 1000 were uniformly clustered in an equally spaced triangular pattern with a pitch distance P of 450 μm, including 480 emitters on each array 1000, though other array geometries and spacings may also be used. In this embodiment, the extractor grid 300 serves as a single piece common ground for the array 1000, allowing each emitter 100 to have a consistent potential gradient (assuming uniform manufacturing) though other arrangements are also possible.

In some embodiments, the pitch distance P may be constant throughout the array 110, whereas in other embodiments, the pitch distance P may change linearly or nonlinearly throughout the array 110, as the present disclosure is not so limited. It should be appreciated that while a square patterned array is shown in FIG. 9A, any suitable array 110 pattern, including, but not limited to, hexagonal, triangular, or any other periodic or aperiodic pattern type may be used as the present disclosure is not so limited. Additionally, depending on the particular array, the pitch distance may either be the same along different axes of the array and/or different pitch distances may be used (e.g. square versus rectangular arrays). In some embodiments, the pitch distance P may be greater than or equal to 1 μm, 10 μm, 100 μm, 500 μm, 1 mm, 5 mm, and/or any other appropriate spacing. The pitch distance may also be less than or equal to 10 mm, 5 mm, 1 mm, 500 μm, 100 μm, 10 μm, and/or any other appropriate spacing. Combinations of the foregoing are contemplated including, for example, a pitch distance that is between or equal to 1 μm and 10 mm. Of course pitch distances different than those noted above are also contemplated as the disclosure is not limited in this fashion.

As noted previously, the spacing of the emitter array 1000 may be similar to the spacing of the extractor grid 300 to enable uniform distribution of applied voltage across the array of emitters 110 and to ensure a similar response for all emitters 100. In other words, the distribution of the emitters of the emitter array 110 may correspond to the spacings of the extractor apertures 310 on the extractor grid 300. As described previously, the scaffolding 600 may enable registration between the emitter array 110 and the extractor grid 300.

As described previously, the emitter 100 may be any suitable geometry as the present disclosure is not so limited. In some embodiments, as shown in FIG. 9B, the emitter 100 may include a root width RW located at a base, or proximal portion of the extractor 30. In some embodiments, the root width RW, which may correspond to a maximum transverse dimension (e.g. a diameter) of an emitter. Depending on the particular embodiment, the root width may be greater than or equal to 1 μm, 10 μm, 20 μm, 50 μm, 100 μm, 200 μm, 300 μm, 400 μm, 500 μm, 1 mm, 1.5 mm, and/or any other appropriate dimension. The root width may also be less than or equal to 2 mm, 1.5 mm, 1 mm, 500 μm, 400 μm, 300 μm, 200 μm, 100 μm, and/or any other appropriate dimension. Combinations of the foregoing are contemplated including, for example, a root width that is between or equal to 1 μm and 2 mm. However, emitters with root widths that are greater than or less than the ranges noted above are also contemplated as the present disclosure is not so limited.

In some embodiments, as shown in FIG. 9B, the emitter 100 may include a base width BW located downstream, or distally from, the root width RW but upstream from the extractor 30. The emitter 100 may also include a height H measured from the tip 101 to the root of the emitter 100. In some embodiments, the height H may be greater than or equal to 1 μm, 10 μm, 20 μm, 50 μm, 100 μm, 200 μm, 300 μm, 400 μm, 500 μm, 1 mm, 1.5 mm, 2.0 mm, and/or any other appropriate dimension. The height may also be less than or equal to 3.0 mm, 2.0 mm, 1.5 mm, 1 mm, 500 μm, 400 μm, 300 μm, 200 μm, 100 μm, and/or any other appropriate dimension. Combinations of the foregoing are contemplated including, for example, a height that is between or equal to 1 μm and 3 mm. However, embodiments in which heights both greater than and less than those noted above are used are also contemplated as the disclosure is not so limited.

As described previously, in some embodiments, the emitter 100 may include a tip 101 to promote the formation of a stable liquid meniscus. While the tip 101 may be any suitable geometry (e.g. conical, spherical, or any other curved or linear geometry), in embodiments where the tip 101 is substantially spherical, the tip 101 may be characterized with a tip radius TR, see FIG. 9B. In some embodiments, the tip radius TR may be greater than or equal to 0.1 nm, 1 nm, 5 nm, 10 nm, 100 nm, 500 nm, 1 μm, 5 μm, 10 μm, 100 μm, and/or any other appropriate dimension. The tip radius may also be less than or equal to 500 μm, 400 μm, 300 μm, 200 μm, 100 μm, 10 μm, 5 μm, 1 μm, 500 nm, 100 nm, and/or any other appropriate dimension. Combinations of the foregoing are contemplated including, for example, a tip radius that is between or equal to 0.1 nm and 500 μm, though any other suitable dimension may also be used as the present disclosure is not so limited.

### Example: Manufacture and Testing

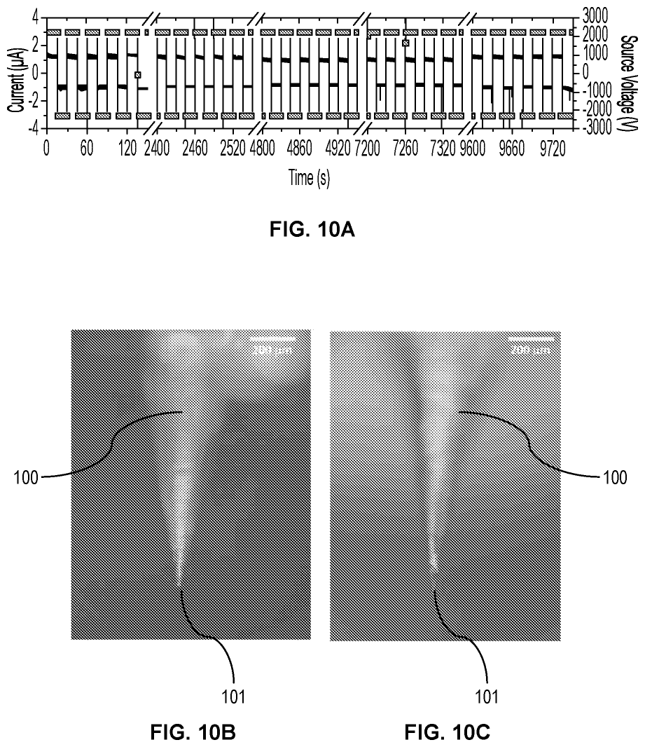

An electrospray device was manufactured using a sulfonated tetrafluoroethylene based fluoropolymer-copolymer (e.g. Nafion) and EMI-BF₄ as an ion source using the methods described above. The resulting device was tested by applying a voltage potential of ±3.0 kV, with a threshold voltage of approximately ±1.8 kV, as shown in FIG. 10A. The resulting measured emitter current was 2-3 μA.

Due to the capacity of the IEP to transport the propellant 40 through the bulk of the emitter 100, the Inventors have appreciated that the majority of degradation processes may be external to the emitter 100 in any electrospray device 110, 120. For example, possible electrochemical reactions may occur upstream of the emitter 100 at the reservoir 41 and propellant 40 interface, while heating may occur downstream of the emitter 100 at the ion beam 20. As a result, the applied voltage may be applied by alternating the polarity with a relatively long period to avoid electrochemical reactions associated with charged species accumulation. In the experiment shown in FIG. 10A, the applied period was 15 seconds. As a result, the emitter 100 of FIG. 10A exhibited stable current emission for nearly 3 hours of continuous firing. Though, it should be appreciated that the emitters described herein may be operated for any suitable duration of time depending on the desired application as the present disclosure is not so limited.

The potential erosion of the emitter 100 or emitter array 1000 was qualitatively explored with optical inspection before and after emission. Specifically, during the emission testing shown in FIG. 10A, the emitter 100 was imaged prior to emission, as shown in FIG. 10B, and after emission, as shown in FIG. 10C. No significant or observable changes in the emitter 100 or emitter tip 101 were observed after approximately 3 hours of emission, which may suggest high stability of the polymer emitter.

In some embodiments of the electrospray device 110, 120, the mass distribution of the emitted species in the ion beam 20 may be used to determine whether undesirable charged droplets (vs. ions or dimers) may be present in the ion beam 20. Droplet emission decreases both the specific impulse and efficiency of the electrospray device 110, 120, and is a common occurrence in electrospray devices with emitters made from non-uniform materials and/or non-uniform emitter morphologies (e.g. porous emitters as shown in FIG. 3A). Time-of-flight (TOF) mass spectrometry was used to establish ion beam 20 composition and to measure ion fractions. The flight times of different species in the ion beam 20 are related to the physical setup and particle properties according to

$$t = L \sqrt{\frac{m}{2 q V}} ,$$

wherein L is the traveling distance, m is the mass of the charged ions and V is the applied potential, as described previously. In some embodiments, the relative fractions of different types of molecular ions may also allow a determination of the average charge to mass ratio, and therefore the specific impulse (at a given voltage potential) and the upper bound of the efficiency of the device.

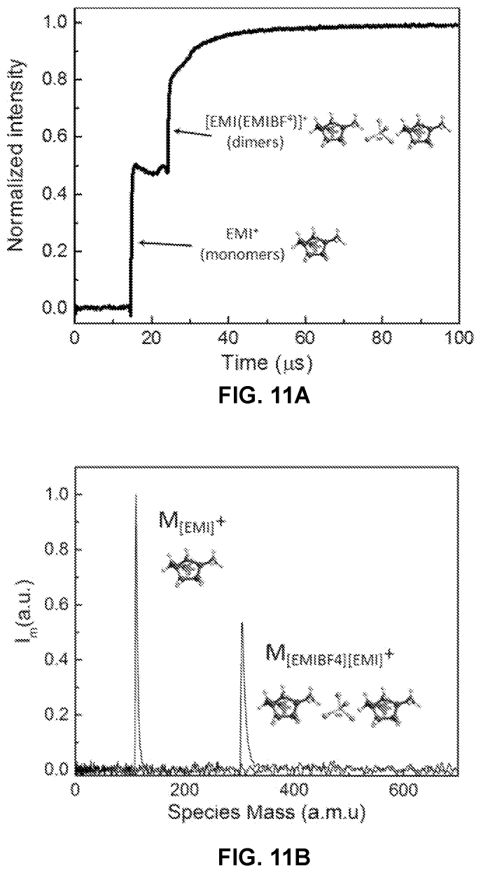

A typical TOF trace of an exemplary emitter 100 with a voltage potential of 2480 V is shown in FIG. 11A. Two distinct steps may be observed in the signal, with flight times of about 14 μs and 24 μs, respectively. Using the equation above, the TOF trace may be converted to a mass spectrum as shown in FIG. 11B. It should be appreciated that the two flight times correspond to the mass of monomers (EMI⁺, 111.2 amu) and dimers ([EMI(EMIBF₄)]⁺, 309.2 amu), respectively. Moreover, as shown in FIG. 11B, monomers and dimers comprise the emitted ion beam 20 while no heavier clusters or droplets were observed. Monomer and dimer emission are purely ionic, and such characteristics point to ideal emission behavior and high efficiency.

Without wishing to be bound by theory, in some embodiments, thrust, specific impulse, and upper bound for efficiency may be calculated based on the TOF data. Using the performed experiments, the calculated thrust of a single IEP emitter was determined to be approximately 0.189 μN, which may be up to an order of magnitude greater than the calculated thrust of other emitter types (e.g. porous emitters, such as the exemplary embodiment shown in FIG. 3A). In some embodiments, the superior thrust performance can be attributed to the high emitter current as well as the high threshold voltage.

The calculated specific impulse of 4725 seconds from the conducted experiments is on the upper end of the specific impulses reported for most types of electrospray devices. The specific impulse is a function of the ion accelerating voltage, which is possible to set independently of the ion extraction voltage for electrospray device, thus allowing emitters to be modulated over a wide range below or above the calculated specific impulse value. In another experiment, an emitter including a sulfonated tetrafluoroethylene based fluoropolymer-copolymer (e.g. Nafion) also exhibited high efficiency at a specific impulse of 3485 seconds.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

1. An electrospray device comprising:
a substrate; and
one or more emitters, wherein the one or more emitters extend from the substrate, and wherein each of the one or more emitters comprises an ionic electroactive polymer.

2. The electrospray device of claim 1, wherein the ionic electroactive polymer is non-porous.

3. The electrospray device of claim 1, wherein the ionic electroactive polymer is a sulfonated tetrafluoroethylene based fluoropolymer-copolymer.

4. The electrospray device of claim 1, further comprising a reservoir configured to contain a liquid ion source operatively coupled with the one or more emitters such that the liquid ion source is transported from the reservoir to the one or more emitters.

5. The electrospray device of claim 4, wherein the reservoir is operatively coupled to the one or more emitters through the substrate.

6. The electrospray device of claim 4, further comprising the liquid ion source disposed in the reservoir, and wherein the liquid ion source comprises at least one of an ionic liquid and a room-temperature molten salt.

7. The electrospray device of claim 4, further comprising a first electrode electrically connected to the one or more emitters through the source of ions and at least a second electrode positioned downstream relative to the one or more emitters and the first electrode.

8. The electrospray device of claim 7, wherein the second electrode is an extractor electrode.

9. The electrospray device of claim 7, wherein the one or more emitters are configured to emit ions when a voltage potential is applied between the first electrode and the second electrode.

10. The electrospray device of claim 1, wherein the substrate comprises at least one selected from the group of a porous material and the ionic electroactive polymer.

11. The electrospray device of claim 1, wherein the one or more emitters include a plurality of emitters disposed in an array.

12. The electrospray device of claim 1, wherein each of the one or more emitters comprises a tip disposed distal from the substrate, and wherein a tip radius of the one or more emitters is between or equal to 0.1 nm and 500 μm.

13. The electrospray device of claim 12, wherein each of the one or more emitters comprises a tip disposed distal from the substrate, and wherein a tip radius of the one or more emitters is between or equal to 20 μm and 30 μm.

14. A method, comprising:
applying a voltage differential to one or more emitters;
diffusing a liquid ion source through a material of the one or more emitters; and
emitting ions from a tip of each of the one or more emitters.

15. The method of claim 14, wherein the material of the one or more emitters comprises an ionic electroactive polymer.

16. The method of claim 14, further comprising transporting the liquid ion source from a reservoir to the one or more emitters.

17. The method of claim 15, wherein the ionic electroactive polymer is non-porous.

18. The method of claim 15, wherein the ionic electroactive polymer is a sulfonated tetrafluoroethylene based fluoropolymer-copolymer.

19. The method of claim 14, wherein the liquid ion source comprises at least one selected from the group of an ionic liquid and a room-temperature molten salt.

20. The method of claim 14, wherein a tip radius of the one or more emitters is between or equal to 0.1 nm and 500 μm.

21. The method of claim 20, wherein a tip radius of the one or more emitters is between or equal to 20 μm and 30 μm.

22. A method of forming an electrospray emitter comprising:
mixing a solution of a solvent, an ionic electroactive polymer, and a liquid ion source; and
molding the mixture to form one or more emitters.

23. The method of claim 22, further comprising pouring the solution into a mold shaped to form the one or more emitter bodies.

24. The method of claim 23, further comprising drying the solution in the mold to form the one or more emitter bodies at least partially from the ionic electroactive polymer.

25. The method of claim 22, wherein the ionic electroactive polymer is non-porous.

26-30. (canceled)
